(19) United States
(12) Patent Application Publication
(10) Pub. No.: US 2007/0183951 A1
(43) Pub. Date: Aug. 9, 2007

(54) Method for recovering noble metals from metallic carrier catalytic device

(76) Inventors: Shigeru Nakatsu, Soka-Shi (JP); Tomonao Yokota, Soka-Shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/590,666

(22) PCT Filed: Mar. 15, 2004
(86) PCT No.: PCT/JP04/03384

§ 371 Date: Aug. 25, 2006

(51) Int. Cl. C01G 55/00

(52) U.S. Cl. 423/22; 502/27; 423/27

(57) ABSTRACT

This invention provides a method for efficiently separating and recovering a wash coat which supports noble metal-containing catalytic component from a metallic carrier of a spent metallic carrier catalytic device for such purposes as the purification of exhaust gas from internal combustion engine, without substantially crushing or dissolving said metallic carrier, which method comprises subjecting a metallic carrier catalytic device which is composed of a metallic carrier having a wash coat provided thereon and a noble metal-containing catalytic component which is supported on the wash coat to a treatment with an aqueous solution of mixed acid which contains sulfuric acid and nitric acid.

### TECHNICAL FIELD

This invention relates to a method for separating and recovering a wash coat which supports noble metal-containing catalytic component, from a metallic carrier of a spent metallic carrier catalytic device, and also to a method for recovering noble metals.

### BACKGROUND ART

As examples of carrier for carrying a catalyst of a catalytic device which is used for purifying exhaust gas from internal combustion engine, there are included ceramic carrier and metallic carrier.

For the purpose of recovering noble metals from a ceramic carrier catalytic device, there is generally employed acid dissolution with use of hydrochloric acid, aqua regia, and the like. When this acid dissolution method is applied to a metallic carrier catalytic device, however, a large amount of acid is required for the dissolution of metallic carrier, and, furthermore, it is difficult to effectively separate noble metals from the resultant solution.

For this reason, various proposals have been offered on how to recover noble metals from a metallic carrier catalytic device.

For instance, Japanese Patent Application KOKAI Publication No. Hei 8-266911 discloses a method for recovering noble metals which comprises applying excess-oxygen flame to a noble metal-carrying metallic carrier which is made of a metal honeycomb body, thus making said honeycomb body burn and fall as oxide particles, grinding the oxide particles and removing oxides by, for instance, magnetic separation, and thereby recovering noble metals. Japanese Patent Application KOKAI Publication No. Hei 11-158563 discloses a method for recovering noble metals from a metallic carrier catalytic converter which comprises heating metallic carrier of a metallic carrier catalytic converter to a high temperature, then quenching the metallic carrier with cool water and thereby peeling a noble metal-containing wash coat layer from said metallic carrier, and thus recovering noble metals from the metallic carrier catalytic converter.

Furthermore, Japanese Patent Application KOKAI Publication No. Hei 8-34619 discloses a method which comprises dipping a metallic carrier catalyst which is composed of a metallic carrier substrate having formed thereon a refractory inorganic oxide layer, which layer contains noble metals, in a solution of 30 volume % or more of sulfuric acid and/or phosphoric acid, heating said solution and dissolving catalytic layer of the metallic carrier catalyst, thereby separating the metallic carrier catalyst into metallic carrier substrate and catalytic layer, and thus recovering noble metals from the resultant solution and from undissolved residue in the catalytic layer. In this method, however, although reaction proceeds mildly when acid solution is being consumed for the dissolution of catalytic layer, metallic carrier substrate is rapidly dissolved as the amount of catalytic layer becomes small, with the result that it becomes hard to selectively separate catalytic layer.

### DISCLOSURE OF INVENTION

The main objective of this invention is to provide a method for efficiently separating and recovering a wash coat which supports noble metal-containing catalytic component, from a metallic carrier of a spent metallic carrier catalytic device for such purposes as the purification of exhaust gas from internal combustion engine, without substantially crushing or dissolving said metallic carrier.

Another objective of this invention is to provide a method for recovering noble metals from thus separated and recovered wash coat which supports noble metal-containing catalytic component.

Other objectives or characteristic features of this invention will clearly be seen in the following explanation.

As a result of assiduous study with a view to achieving the above-mentioned objectives, the inventors of this invention have found out that, when a spent metallic carrier catalytic device is treated with an aqueous solution of mixed acid which contains sulfuric acid and nitric acid, wash coat which supports noble metal-containing catalytic component can easily be separated and recovered from the metallic carrier without substantial dissolution of the metallic carrier, and, thus, they have completed this invention.

Thus, this invention provides a method for separating and recovering a catalytic component-supporting wash coat from a metallic carrier catalytic device, which method is characterized in that a metallic carrier catalytic device which is composed of a metallic carrier having a wash coat thereon and of a noble metal-containing catalytic component which is supported on the wash coat, is treated with an aqueous solution of mixed acid which contains sulfuric acid and nitric acid.

This invention also provides a method for recovering noble metals from a metallic carrier catalytic device, which is characterized in that noble metals are recovered by any known method from catalytic component-supporting wash coat which has been separated and recovered by the above-mentioned method, and from recovered aqueous solution of mixed acid.

### BRIEF DESCRIPTION OF DRAWINGS

FIG. 1 is a flow sheet which roughly shows the methods as used in Examples 1 and 2.

In the following, the method of this invention is explained in more detail.

Examples of metallic carrier catalytic device which is to be treated by the method of this invention includes a device which comprises a metallic carrier of such a structure as honeycomb structure formed by foil of heat-resistant metal such as heat-resistant stainless steel and iron-chromium-aluminum alloy, on the surface of which carrier is formed a porous layer of refractory inorganic oxide such as activated alumina and zirconia, i.e., a wash coat, which layer supports catalytic component of noble metals such as platinum, rhodium and palladium; and a device comprising a metallic carrier which supports catalytic component as mentioned above and which is encapsulated in an outer cylinder made of heat-resistant metal. These devices have widely been used for the purification of exhaust gas from various kinds of combustion engines such as those of car, boiler, and the like. In the case of cars, the catalytic devices are disposed of after the cars have been put out of service; in boilers, the catalytic devices are replaced when their catalytic performance decreases.

In this invention, such a spent metallic carrier catalytic device is treated with an aqueous solution of mixed acid which contains sulfuric -acid and nitric acid. In this aqueous solution of mixed acid, sulfuric acid mainly dissolves metal oxides such as alumina which are contained in wash coat, and serves to thereby render wash coat brittle; nitric acid forms an oxide layer on the surface of metallic carrier, and thereby prevents the metallic carrier from being dissolved by sulfuric acid, or serves to protect the metallic carrier from dissolution.

In the aqueous solution of mixed acid which is used for the present invention, the concentration of sulfuric acid and of nitric acid is not strictly restricted, but may vary according to the material, the shape, or the like, of metallic carrier catalytic device to be treated. Generally, however, the concentration of sulfuric acid may be in the range of 5 to 50% by weight, preferably 7.5 to 40% by weight, more desirably 10 to 30% by weight; the concentration of nitric acid may be in the range of 0.1 to 5% by weight, preferably 0.5 to 4% by weight, more desirably 1 to 3% by weight.

Said aqueous solution of mixed acid may contain, where necessary, optional component such as phosphoric acid, acetic acid, oxalic acid, citric acid, and salt thereof, in a small amount or, preferably, at a concentration in the range of 1 to 5% by weight.

The above-mentioned treatment of metallic carrier catalytic device with aqueous solution of mixed acid is conducted, for instance, by dipping a spent metallic carrier catalytic device in an aqueous solution of mixed acid. In that case, the temperature of said aqueous solution of mixed acid is not strictly restricted. Generally, however, it may be in the range of from room temperature to about 150° C. At a low temperature, however, the dissolution of wash coat layer takes time. The treatment is therefore usually conducted preferably at a temperature of about 60° C. to about 100° C. Although treating time is also not particularly restricted, reaction is preferably brought to an end before nitric acid has been consumed and no oxide layer is newly formed any more. This treatment with aqueous solution of mixed acid may be conducted plural times where necessary.

Thus, a considerable part of wash coat layer which supports noble metal-containing catalytic component on metallic carrier of a metallic carrier catalytic device is dissolved in the mixed acid. Depending on treating condition, some part of wash coat layer is peeled off the metallic carrier in an undissolved state, and is separated and recovered in the mixed acid in the form of undissolved residue. Metallic carrier, on the other hand, can be taken from the aqueous solution of mixed acid without being substantially dissolved.

The aqueous solution of mixed acid which contains thus separated and recovered noble metal component-supporting wash coat in a dissolved state, and, according to circumstances, also contains undissolved residue as well, is then separated, by a usual solid-liquid separating means, into an aqueous solution of mixed acid which contains catalytic component-supporting wash coat dissolved therein and undissolved residue, from each of which noble metals can be recovered by any known noble metal-recovering method, e.g., the method which is mentioned in “Outline of High Purity Technology, Volume 3, Process for Manufacture of High Purity Substance, Section IV, pp 573-576” (published on Dec. 12, 1997, by Fujitec Corporation, under the supervision of Haruhiko OYA, professor of Yokohama National University, Department of Engineering, Course of Material Engineering).

Specifically, aqueous solution of mixed acid which contains catalytic component-supporting wash coat dissolved therein is subjected to a reduction treatment with a reduction material such as hydrogen and iron powder, and, thus, noble metal can be deposited from said aqueous solution. Thus deposited noble metal is, where necessary, dissolved in aqua regia for further purification. Undissolved residue, on the other hand, is dissolved in aqua regia, and, from the resultant solution, noble metal can be recovered by a usual method (e.g., precipitation separation method).

According to the method of this invention as described above, metallic carrier catalytic device is treated with an aqueous solution of mixed acid which contains sulfuric acid and nitric acid. Sulfuric acid acts so as to dissolve catalytic component-supporting wash coat layer, and, simultaneously, nitric acid acts so as to form an oxide layer on the surface of metallic carrier and thereby prevents the metallic carrier surface from being dissolved by sulfuric acid. As a result, catalytic component-supporting wash coat can be effectively separated and recovered from the metallic carrier without substantial dissolution of metallic carrier.

### EXAMPLES

The method of this invention is explained by the following Examples in more detail. It should be understood that the Examples do not restrict the scope of this invention.

### Referential Example 1

A heat-resistant stainless steel honeycomb body having a diameter of 900 mm and a height of 1260 mm (hereinafter referred to as metallic carrier; volume: 800 cc) was coated with 140 g of activated alumina, was burned, and was then made to support 0.3 g of platinum (Pt), 2.3 g of palladium (Pd) and 0.3 g of rhodium (Rh) per one metallic carrier, and, thus, a metallic carrier catalytic device was manufactured.

### Example 1

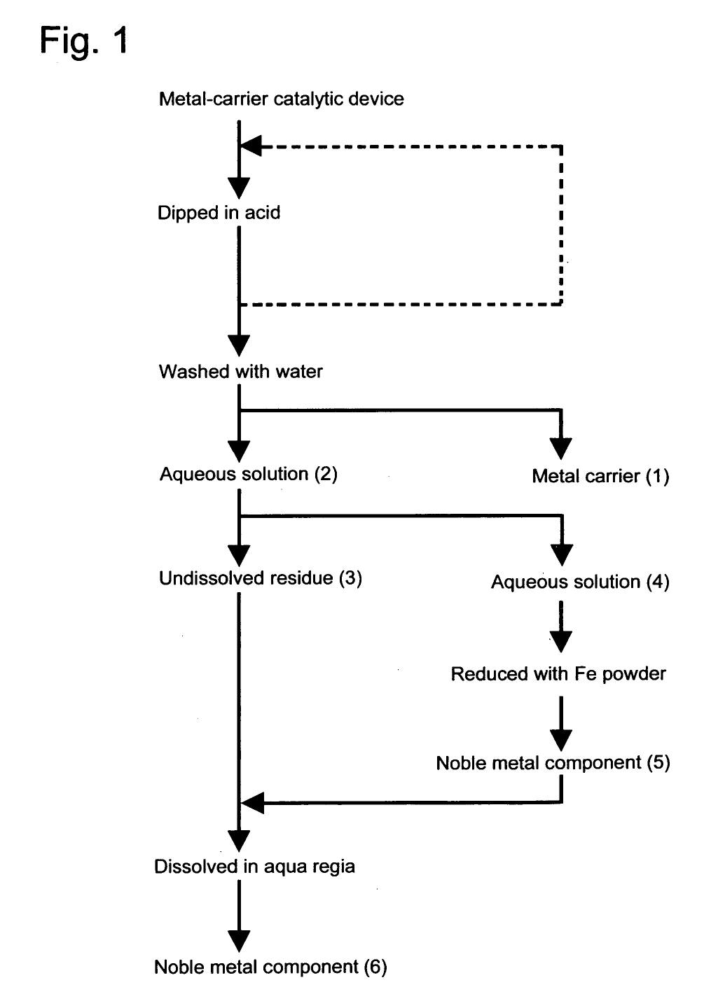

In accordance .with the flow sheet as shown in FIG. 1, the metallic carrier catalytic device as manufactured in Referential Example 1 was dipped in an aqueous solution which contained 20% by weight of sulfuric acid and 2% by weight of nitric acid, and was thus treated at 80° C. for five hours. After left to cool down, the metallic carrier (1) was taken from said aqueous solution, and was washed with water. Thus obtained wash liquid and the above-mentioned aqueous solution were put together to give an aqueous solution (2) which contained undissolved residue. The recovered metallic carrier had the same appearance as before coated with activated alumina, and showed no sign of dissolution at all.

Aqueous solution (2) was separated, by filtration, into undissolved residue (3) and aqueous solution (4). Aqueous solution (4) was subjected to a reduction treatment by the addition of 10 g of iron (Fe) powder, and, thus, noble metal (Pt, Pd, Rh) component (5) was deposited and recovered. Subsequently, thus recovered noble metal component (5) and undissolved residue (3) were put in aqua regia and dissolved therein to give noble metal component (6) in the form of solution. Noble metal component which remained on metallic carrier (1) and noble metal component (6) in the form of solution were each analyzed by IPC (inductively coupled argon plasma) emission spectrometry, and, thus, the amount of Pt, Pd and Rh was measured. Results are shown in Table 1.

### Example 2

In accordance with the flow sheet as shown in FIG. 1, the metallic carrier catalytic device as manufactured in Referential Example 1 was dipped in an aqueous solution which contained 20% by weight of sulfuric acid and 2% by weight of nitric acid, and was thus treated at 80° C. for five hours. Metallic carrier (1) was then taken from said aqueous solution, and was subsequently dipped in a newly prepared aqueous solution which contained 20% by weight of sulfuric acid and 2% by weight of nitric acid, and was thus treated again at 80° C. for five hours. After left to cool down, the metallic carrier was washed with water. Thus obtained wash liquid and the above-mentioned aqueous solution were put together to give an aqueous solution (2) which contained undissolved residue. The recovered metallic carrier had the same appearance as before coated with activated alumina, and showed no sign of dissolution at all.

Aqueous solution (2) was separated, by filtration, into undissolved residue (3) and aqueous solution (4). Aqueous solution (4) was subjected to a reduction treatment by the addition of 10 g of iron (Fe) powder, and, thus, noble metal (Pt, Pd, Rh) component (5) was deposited and recovered. Subsequently, thus recovered noble metal component (5) and undissolved residue (3) were put in aqua regia and dissolved therein to give noble metal component (6) in the form of solution. Noble metal component which remained on metallic carrier (1) and noble metal component (6) in the form of solution were each analyzed in the same manner as in Example 1, and, thus, the amount of Pt, Pd and Rh was measured. Results are shown in Table 1.

### Comparative Example 1

The same operation as Example 1 was carried out except that an aqueous solution which contained 20% by weight of sulfuric acid was used in place of aqueous solution which contained 20% by weight of sulfuric acid and 2% by weight of nitric acid, and that dipping treatment was conducted three times, each time with newly prepared aqueous solution as mentioned above. Results are shown in Table 1. It was confirmed that a part of metallic carrier (1) had dissolved by this dipping treatment.

### Comparative Example 2

The same operation as Example 1 was carried out except that an aqueous solution which contained 30% by weight of sulfuric acid and 5% by weight of phosphoric acid was used in place of aqueous solution which contained 20% by weight of sulfuric acid and 2% by weight of nitric acid, and that dipping treatment was conducted three times, each time with newly prepared aqueous solution as mentioned above. Results are shown in Table 1. It was confirmed that a part of metallic carrier (1) had dissolved by this dipping treatment.

### Comparative Example 3

The same operation as Example 1 was carried out except that an aqueous solution which contained 30% by weight of phosphoric acid was used in place of aqueous solution which contained 20% by weight of sulfuric acid and 2% by weight of nitric acid, and that dipping treatment was conducted three times, each time with newly prepared aqueous solution as mentioned above. Results are shown in Table 1. It was confirmed that a part of metallic carrier (1) had dissolved by this dipping treatment.

TABLE 1

| | | Pt | Pd | Rh |
|---|---|---|---|---|
| Example 1 | Noble metal component remaining in metallic carrier (1) (g) | 0.02 | 0.30 | 0.06 |
| | Noble metal component (6) in the form of solution (g) | 0.27 | 1.99 | 0.23 |
| | Noble metal component recovery rate (%)* | 93.1 | 86.8 | 79.3 |
| Example 2 | Noble metal component remaining in metallic carrier (1) (g) | 0.00 | 0.00 | 0.00 |
| | Noble metal component (6) in the form of solution (g) | 0.31 | 2.33 | 0.31 |
| | Noble metal component recovery rate(%) * | 99.9 | 99.9 | 99.9 |
| Comparative | Noble metal component remaining in metallic carrier (1) (g) | 0.08 | 0.61 | 0.16 |
| example 1 | Noble metal component (6) in the form of solution (g) | 0.21 | 1.74 | 0.17 |
| | Noble metal component recovery rate (%)* | 72.4 | 74.0 | 51.5 |
| Comparative | Noble metal component remaining in metallic carrier (1) (g) | 0.13 | 1.00 | 0.15 |
| example 2 | Noble metal component (6) in the form of solution (g) | 0.16 | 1.32 | 0.14 |
| | Noble metal component recovery rate (%)* | 55.2 | 56.9 | 48.3 |
| Comparative | Noble metal component remaining in metallic carrier (1) (g) | 0.24 | 1.90 | 0.27 |
| example 3 | Noble metal component (6) in the form of solution (g) | 0.06 | 0.43 | 0.05 |
| | Noble metal component recovery rate (%)* | 20.0 | 18.5 | 15.6 |

$\begin{matrix}* Rate of noble metal in the form of solution ( \% ) = \\ \frac{Noble metal component in the form of solution ( g )}{\begin{matrix}Noble metal component remaining in metallic carrier ( g ) + \\ Noble metal component in the form of solution ( g )\end{matrix}} \times 100\end{matrix}$

1. A method for separating and recovering a catalytic component-supporting wash coat from a metallic carrier catalytic device, which method is characterized in that a metallic carrier catalytic device which is composed of a metallic carrier having a wash coat provided thereon and a noble metal-containing catalytic component which is supported on the wash coat is treated with an aqueous solution of mixed acid which contains sulfuric acid and nitric acid.

2. A method of claim 1 wherein the aqueous solution of mixed acid contains sulfuric acid at a concentration in the range of 5 to 50% by weight and nitric acid at a concentration in the range of 0.1 to 5% by weight.

3. A method of claim 1 wherein the aqueous solution of mixed acid contains sulfuric acid at a concentration in the range of 10 to 30% by weight and nitric acid at a concentration in the range of 1 to 3% by weight.

4. A method of claim 1 wherein the treatment with aqueous solution of mixed acid is conducted at a temperature in the range of from room temperature to about 150° C.

5. A method for recovery of claim 1 wherein the treatment with aqueous solution of mixed acid is conducted at a temperature in the range of from about 60° C. to about 100° C.

6. A method for recovering noble metals from a metallic carrier catalytic device, wherein noble metals are recovered by any known method from catalytic component-supporting wash coat which has been separated and recovered by a method as mentioned in claim 1, and from recovered aqueous solution of mixed acid.

7. A method for recovering noble metals from a metallic carrier catalytic device, wherein noble metals are recovered by any known method from catalytic component-supporting wash coat which has been separated and recovered by a method as mentioned in claim 2, and from recovered aqueous solution of mixed acid.

8. A method for recovering noble metals from a metallic carrier catalytic device, wherein noble metals are recovered by any known method from catalytic component-supporting wash coat which has been separated and recovered by a method as mentioned in claim 3, and from recovered aqueous solution of mixed acid.

9. A method for recovering noble metals from a metallic carrier catalytic device, wherein noble metals are recovered by any known method from catalytic component-supporting wash coat which has been separated and recovered by a method as mentioned in claim 4, and from recovered aqueous solution of mixed acid.

10. A method for recovering noble metals from a metallic carrier catalytic device, wherein noble metals are recovered by any known method from catalytic component-supporting wash coat which has been separated and recovered by a method as mentioned in claim 5, and from recovered aqueous solution of mixed acid.
